(19) United States
(12) Patent Application Publication
(10) Pub. No.: US 2006/0086456 A1
(43) Pub. Date: Apr. 27, 2006

(54) Method and system for forming a seal between web panels

(76) Inventor: Gregory A. Rawley, Wynnewood, PA (US)

Correspondence Address: Daniel H. Golub, 1701 Market Street, Philadelphia, PA, 19103, US

(21) Appl. No.: 10/974,041

(22) Filed: Oct. 26, 2004

(51) Int. Cl. B32B 37/00; B32B 38/04; B32B 38/10

(52) U.S. Cl. 156/258; 156/304.5; 156/502; 156/517

(57) ABSTRACT

A system and method to joins foam panels. The first panel has a first upper surface, a first lower surface and a first beveled edge that connects the first upper surface to the first lower surface. The first upper surface and first lower surface are both aligned parallel to a common plane. The first beveled edge is positioned at a first angle that is other than 90° with respect to the common plane. A second panel has a second upper surface, a second lower surface and a second beveled edge that connects the second upper surface to the second lower surface. The second upper surface and second lower surface are both aligned parallel to the common plane. The second beveled edge is positioned at a second angle wherein the first and second angles are supplementary angles. The adhesive layer is placed between the first and second beveled edges with first beveled edge and the second beveled edge overlapped at a joinder position. The first upper surface of the first panel and the second upper surface of the second side panel meet at the joinder position to form an essentially flat surface. The first lower surface of the first panel and the second lower surface of the second side panel meet at the joinder position to form an essentially flat surface.

### FIELD OF THE INVENTION

The present invention is directed to a system and method for forming a seal between foam panels such as, for example, those used in the manufacture of automobile headliners.

### BACKGROUND

In the manufacture of automobile headliners, open cell polyurethane foam (“foam”) is used in the lamination of foam and fabric to form the headliner. The foam is typically adhered to a firm backing such as fiberglass in a thermoform process. A defective headliner results if the foam contains a seam that produces a visible defect, such as a bump or line.

Open cell polyurethane foam is produced by a foam pouring process. The foam is produced in molded blocks that is then peeled to form sheets which are rolled into foam rolls. The foam rolls are then used in a continuous production process for the lamination of foam and fabric to form automobile headliners. During the production process, individual foam rolls are seamed together to extend the dimensions of the foam sheet. Typically, a hotwire process is used to seam, face to face without overlap, the end edge of one foam roll with the beginning edge of the next foam roll. Hot wire sealing, however, causes a defect because it compresses and seals the end edges of the polyurethane rolls, resulting in a compressed seam. Other seaming methods that use a rubber adhesive also adversely affects the compression causing similar defects to those formed by hot wire sealing. The compressed seam is unsuitable for use in an automobile headline because it creates a visible defect. When the joined foam rolls are rolled into a single foam roll, the compressed seam, leaves impression marks on the foam areas located above and below the compressed seam in the foam roll. The impression marks create additional defective foam material. This invention provides a seam with minimal change to the polyurethane foam compression properties resulting in less defective foam material.

### SUMMARY OF THE INVENTION

The present invention is directed to a system that joins foam panels. The system is comprised of a first panel, a second panel and an adhesive layer. The first panel has a first upper surface, a first lower surface and a first beveled edge that connects the first upper surface to the first lower surface. The first upper surface and first lower surface are both aligned parallel to a common plane. The first beveled edge is positioned at a first angle that is other than 90° with respect to the common plane. The second panel has a second upper surface, a second lower surface and a second beveled edge that connects the second upper surface to the second lower surface. The second upper surface and second lower surface are both aligned parallel to the common plane. The second beveled edge is positioned at a second angle wherein the first and second angles are supplementary angles. The adhesive layer is placed between the first and second beveled edges with first beveled edge and the second beveled edge overlapped at a joinder position. The first upper surface of the first panel and the second upper surface of the second side panel meet at the joinder position to form an essentially flat surface. The first lower surface of the first panel and the second lower surface of the second side panel also meet at the joinder position to form an essentially flat surface.

The present invention is furthermore directed to a method for forming a seal between panels of foam material. An edge of a first panel is aligned to an edge of a second panel. The first panel has a first upper surface, a first lower surface and a first beveled edge that connects the first upper surface to the first lower surface. The first upper surface and first lower surface are both aligned parallel to a common plane. The second panel has a second upper surface, a second lower surface and a second beveled edge that connects the second upper surface to the second lower surface. The second upper surface and second lower surface are both aligned parallel to the common plane. The lower surface of the first and second panel are secured to a surface. An edge of the first panel is cut at a first angle that is other than 90° with respect to the common plane, to form a first beveled edge. An edge of the second panel is cut at a second angle to form a second beveled edge, wherein the first and second angles are supplementary angles. Adhesive is applied to at least one of the first beveled edge and the second beveled edge. The first and second beveled edges are aligned. The first and second beveled edges are joined to form the seam, wherein the first and second beveled edges overlap at a joinder position. The first upper surface of the first panel and the second upper surface of the second side panel also meet at the joinder position to form an essentially flat surface. The first lower surface of the first panel and the second lower surface of the second side panel meet at the joinder position to form an essentially flat surface.

### BRIEF DESCRIPTION OF THE DRAWINGS

The accompanying drawings, which are included to provide further understanding of the invention and are incorporated in and constitute a part of this specification, illustrate embodiments of the invention and, together with the description, serve to explain the principles of the invention.

In the drawings:

FIGS. 1A through 1C illustrate cross-section views a system of the present invention;

FIG. 2 illustrates a device of the present invention;

FIG. 3 illustrates a device of the present invention; and

FIG. 4 is a flow chart illustrating a method of a preferred embodiment of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers will be used throughout the drawings to refer to the same or like parts.

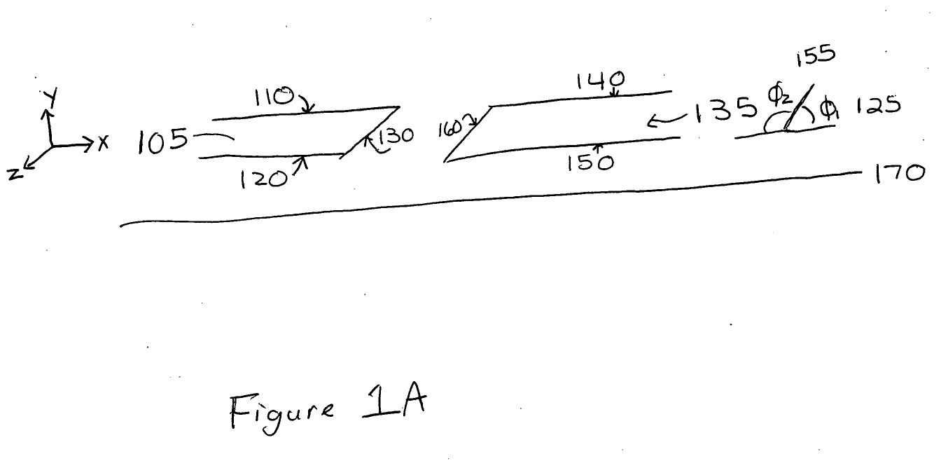

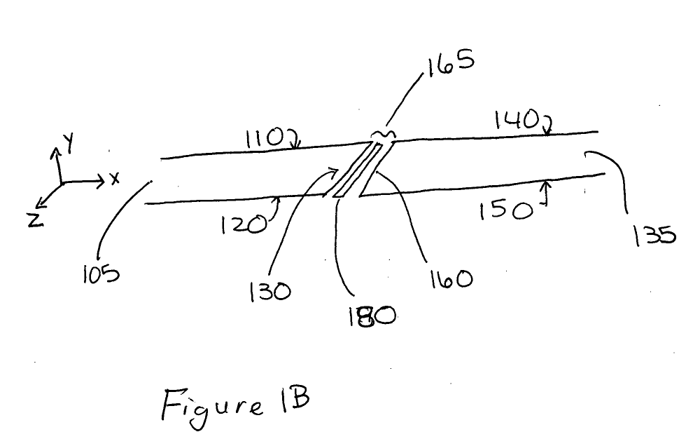

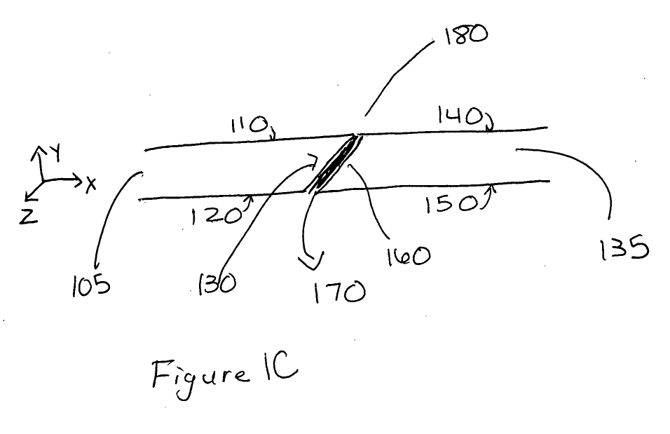

FIG. 1A illustrates a cross-sectional view of a system to join foam panels or rolls according to the present invention. The foam thickness is indicated by dimensions in the z-axis, the foam width is indicated by dimensions in the y-axis and the foam length is indicated by dimensions in the x-axis. Any foam material may be employed in the present invention. Examples of suitable foam material include polyether or polyester based urethane foams and foams from vinyl polymers such as polyvinyl chloride and its copolymers. Typical dimensions for a foam panel may range from 0.05 inches to 12 inches in thickness, to 6 inches in width and from 6 inches to 12 feet in length. Typical dimensions for a form roll may range from 0.05 inches to 0.5 inches, 32 inches to 80 inches in width and 10 yards to 400 yards in length.

The present invention will be illustrated with reference to joining two foam panels. However, the present invention is equally applicable to joining more than two foam panels. It is also equally applicable to joining two or more foam rolls. Such embodiments are within the scope of the present invention. With reference to FIG. 1, the first foam panel 105 has a first upper surface 110 and a first lower surface 120. The first upper surface 110 and the first lower surface 120 are both aligned parallel to a common plane 170. The first upper surface 110 and the first lower surface 120 of the first foam panel 105 are connected by a first beveled edge 130. The first beveled edge is positioned at an angle 125 that is other than 90° with respect to the common plane 170. Likewise, the second foam panel 135 has a second upper surface 140 and a second lower surface 150. The second upper surface 140 and the second lower surface 150 are both aligned parallel to the common plane 170. The second upper surface 140 and the second lower surface 150 of the second foam panel 135 are connected by a second beveled edge 160. The second beveled edge 160 is positioned at a second angle 155 wherein the first angle 125 and the second angle 155 are supplementary angles.

With reference to FIG. 1B, the first foam panel 105 and the second foam panel 135 are overlapped at a joinder position 165 with an adhesive layer 180 placed between the first beveled edge 130 and the second beveled edge 160. The adhesive layer 180 may be comprised of any suitable material having sufficient bonding strength to adhere to and unite the first foam panel 105 and the second foam panel 135. Suitable adhesives include, 3M™ Adhesive Transfer Tape 9453FL 3.5 mil, 300 high strength acrylic adhesive on 2.0 mil, polyester film liner and high bond to plastics with high temperature holding 2.0 mil, high strength 300LSE adhesive with 2.0 mil, polyester film liner. As illustrated in FIG. 1C, the first upper surface 110 of the first panel 105 and the second upper surface 140 of the second panel 135 are next brought together at the joinder position 165 to form an essentially flat surface. Likewise, the first lower surface 120 of the first panel 105 and the second lower surface 150 of the second panel 135 meet at the joinder position 165 to form an essentially flat surface.

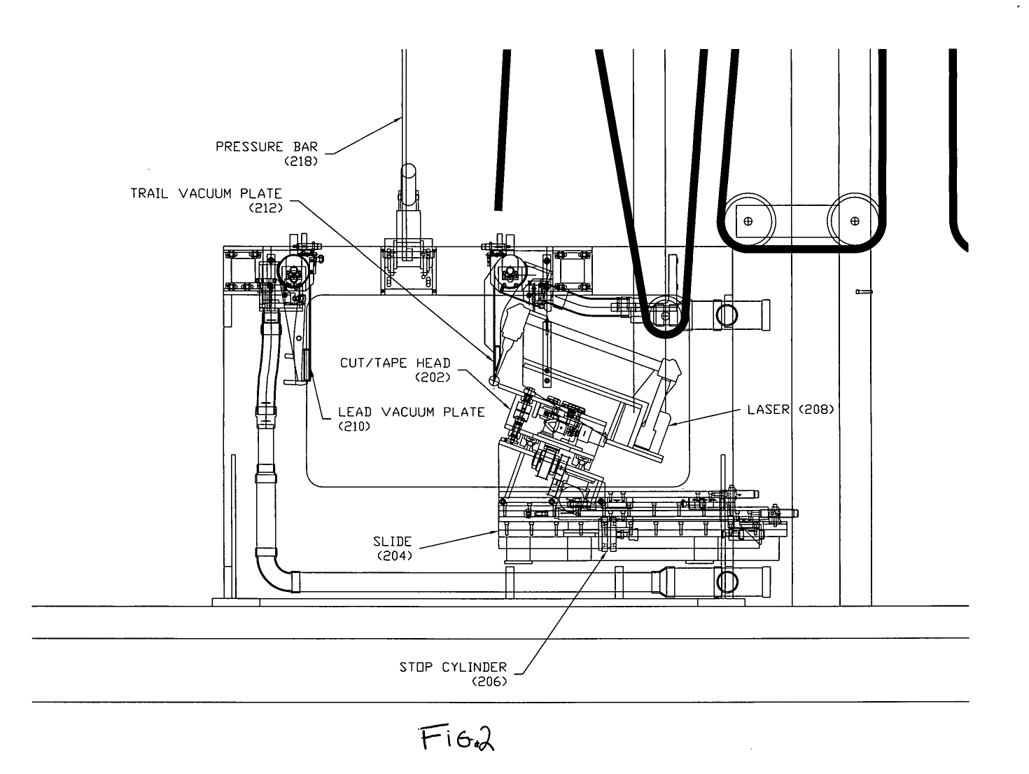

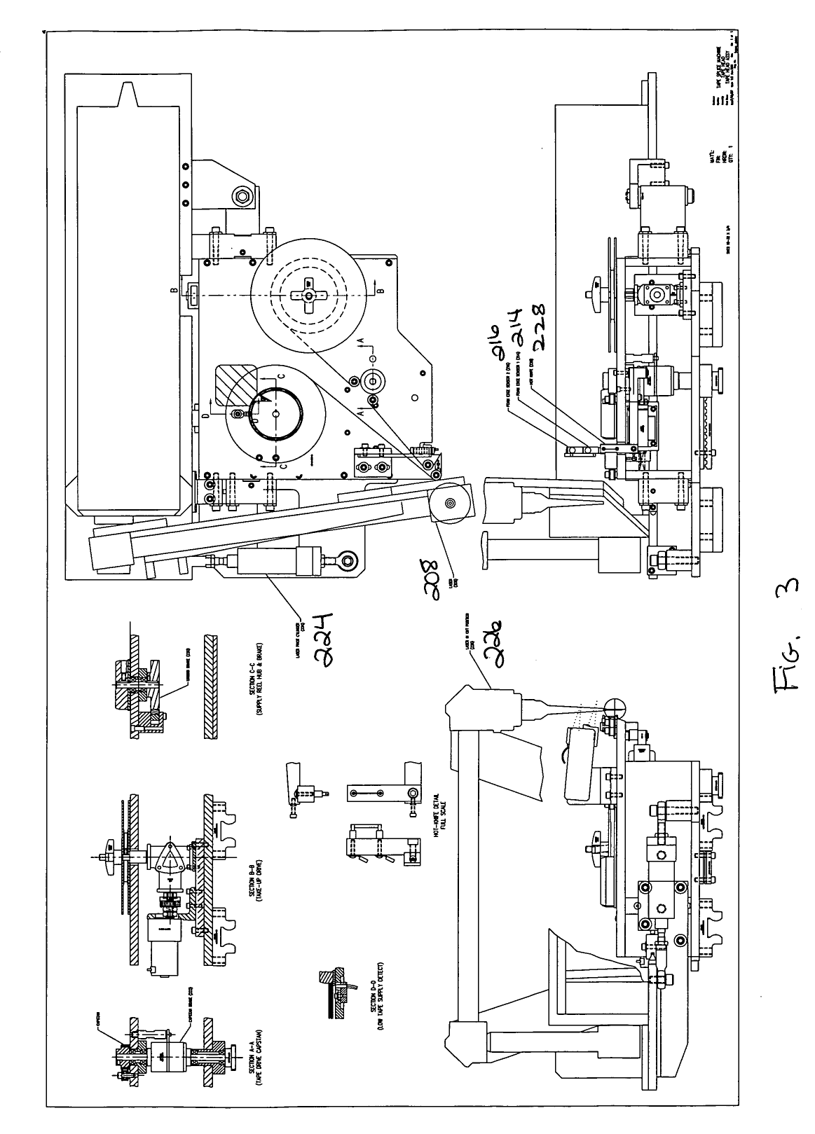

The device used to cut the foam panels and seal the panels is illustrated in FIGS. 2 and 3. As illustrated, the device includes laser 208 used to cut both the leading and trailing edges of the foam to prepare them for joining. Slide 204 is used for moving the laser 208 between the lead cut position 226 and trailing cutting positions. Stop cylinder 206 controls the slide 204 when the laser 208 is in the lead cut position 226 by releasing the slide 204 for the fine adjustment required to position the tape dispenser into position above the beveled edges of the foam panels. The laser pivot cylinder 224 works in conjunction with the stop cylinder 206 by swinging the laser 208 out of the way of the tape dispenser as it approaches its taping position above the beveled edges of the foam panels. Cut/tape head 202 dispenses the adhesive tape to the leading beveled edge of the foam. Lead vacuum plate 210 holds the leading edge of the uncut foam in place to ensure proper foam positioning for the laser cut. Trail vacuum plate 212 holds the trailing edge of the uncut foam in place to ensure proper foam positioning for the laser cut. Foam edge sensor no. one 214 is used to trigger the tape dispenser as it travels across the side edge of the foam preventing the tape from adhering the foam to the machine surface. Foam edge sensor no. two 216 is used to trigger the hot knife 228 which cuts the adhesive tape to the appropriate length, ensuring that the adhesive tape is only applied to the foam. Pressure bar 218 is used to compress the joined seam causing the adhesive tape to adhere sufficiently to both pieces of foam. Unwind brake 220 makes sure the adhesive tape stops immediately at time of cut. Capstan brake 222 stops the motion of the release paper on the back of the adhesive tape.

The present invention is also directed to a method for forming a seal between panels of foam material. The present invention will be illustrated with reference to joining two foam panels wherein the panels are rolled into rolls. However, the present invention is equally applicable to joining foam panels packaged in different manners. The method will be illustrated with reference to cutting the first and second panels individually. However, the present invention is equally applicable to cutting the panels simultaneously. In the case of foam rolls, rolls of foam are loaded on a turret unwinder. A roll is unrolled and the end is pulled overtop a stationary roller until a foam surface suitable for forming a seal is obtained. After this unrolling step or other initial preparation steps of the foam rolls or foam panels, a lead end of a first foam panel 105 is placed on a lead vacuum plate 210. The first foam panel 105 is positioned so to align the sides and the lead edge of the first foam panel 105 with the x-axis and y-axis of the lead vacuum plate 210. The upper surface 110 and lower surface 120 of the first foam panel 105 are aligned parallel to a common plane 170. The vacuum is then turned on to secure the first foam panel 105. A foam panel may be secured to a variety of aligning device using various means such as vacuum, force, clamps. The slide 204 extends to the stop cylinder and the laser 208 turned on. The laser 208 is placed in the z-axis above or below the first foam panel 105 to cut the lead edge of first foam panel 105 at a first angle 125. The first foam panel 105 is cut so that the first angle 125 is other than 90° from the common plane 170 of the upper surface 110 and lower surface 120 of first foam panel 105. The measure of first angle 125 is relative to the location of the first foam panel 105 and the laser 208. When the laser 208 is placed above the frame the cut angle is greater than 90°. The laser 208 then cuts first foam panel 105 to form a beveled end edge 130. The cut/tape head 202 traverses to the near side of the foam panel relative to the operator position while cutting the first foam panel 105. The laser 208 is then turned off while the cut/tape head 202 returns to the far side of the foam panel. The foam edge sensor no. one 214 detects the side edge of the first foam panel 105. At the same time, laser 208 is moved back to its pivot position. Adhesive tape is then applied to the beveled end edge 130 of the first foam panel 105. Adhesive may be applied with pressure sensitive tape. The adhesive tape is unrolled with an automatic dispenser and controlled feed speed. To drive the tape, the capstan brake 222 is in the off position and the clutch in the on position. The stop cylinder 206 retracts so the slide 204 can advance and place adhesive tape on the beveled end edge 130 of first foam panel 105. Foam edge sensor no. two 216 then detects the far side edge of foam panel 105. At the same time, the capstan brake 222 is placed the off position and the clutch in the off position. A hot knife 228 is used to cut the adhesive tape. In low volume situations, the operator may move the dispenser by hand, though its location is critical, so it must ride on a linear guide system. The adhesive tape is dispensed using an unwind and lay down process. The adhesive tape is pressed onto the beveled end edge 130 of foam panel 105, though not with too much pressure as to compression of the foam. The slide 204 then returns to the home position. The trail vacuum plate 212 is rotated into the down position followed by placing the trail edge of second foam panel 135 on the trail vacuum plate 212. The second foam panel 135 is then positioned onto the trail vacuum plate 212 to align the sides and the trail edge of second foam panel 135 with the x-axis and y-axis of the trail vacuum plate 212. The upper surface 140 and lower surface 150 of second foam panel 135 are also aligned parallel to a common plane 170. The vacuum is then turned on. To cut the beveled trail edge of second foam panel 135, laser 208 is turned on and placed in the z-axis above or below second foam panel 135 at a second angle 155. The laser 208 cuts the second foam panel 135 at the second angle 155 to form the beveled lead edge 160. The second foam panel 135 is cut so that the first angle 125 of the beveled lead edge 130 and second angle 155 of the beveled trail edge 160 are supplementary angles. The cut/tape head 202 traverses to the near side while cutting second foam panel 135. The laser 208 is then turned off with the cut/tape head 202 returning to the far side. The trail vacuum plate 212 rotates to the up position and the lead vacuum plate 210 rotates to the up position. The beveled end edge 130 of the first foam panel 105 is aligned parallel to the beveled trail edge 160 of the second foam panel 135. The first beveled end edge 130 and the second beveled trail edge 160 are aligned and joined to form a seam. During the joining process, the beveled end edge 130 and the beveled trail edge 160 are overlapped at a joinder position 165. The beveled end edge 130 and the beveled trail edge 160 are positioned in such as manner so that the upper surface 110 of the first foam panel 105 and the upper surface 140 of the second foam panel 135 form an essentially flat surface. The beveled end edge 130 and the beveled trail edge 160 are also positioned so that the lower surface 120 of the first foam panel 105 and the lower surface 150 of the second foam panel 135 form an essentially flat surface. The pressure bar 218 extend down to seal the beveled end edge 130 of the first foam panel 105 to the beveled trail edge 160 of the second foam panel 135. A tamping bar(s) is used to apply pressure to insure a good seal between the first foam panel 105 and the second foam panel 135. The vacuum is turned off and the joined foam panels removed or subsequent panels attached in a similar manner. During the cutting and sealing process, pressurized air may be used to blow off smoke and fumes so not to affect the product quality negatively, and for operator safety.

Various lasers may be used to cut the foam depending upon the foam type. For example, for a foam panel with a thickness up to 0.25 inch a CO₂ laser of 100 watts is suitable. For foam panel with a thickness of 0.5 inch, such as that used in auto mobile body cloth, a CO₂ laser of 200 watts is suitable. Diode lasers are also suitable. The laser power setting is controlled depending up the foam thickness.

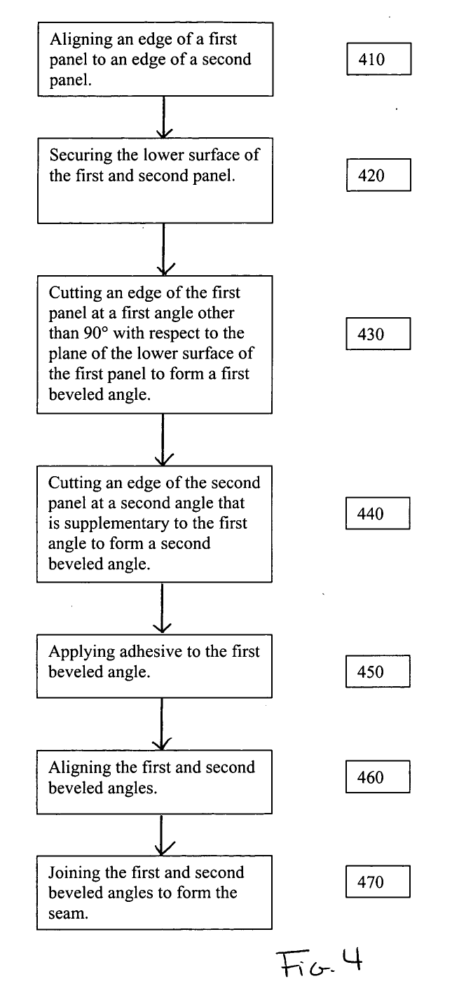

With reference to FIG. 4, a flow chart is shown illustrating a preferred embodiment of the method of the present invention. In step 410, an edge of a first panel is aligned to an edge of a second panel. In step 420, the lower surface of the first and second panel are secured to a surface. In step 430, an edge of the first panel is cut at a first angle that is other than 90° with respect to a common plane of the lower surface of the first panel, to form a first beveled edge. In step 440, an edge of the second panel is cut at a second angle to form a second beveled edge, wherein the first and second angles are supplementary angles. In step 450, adhesive is applied to the first beveled edge. In step 460, the first and second beveled edges are aligned. In step 470, the first and second beveled edges are joined to form the seam, wherein the first and second beveled edges being overlapped at a joinder position.

The present invention may be embodied in other specific forms without departing from the spirit or essential attributes of the invention. Accordingly, reference should be made to the appended claims, rather than the foregoing specification, as indicating the scope of the invention. Although the foregoing description is directed to the preferred embodiments of the invention, it is noted that other variations and modification will be apparent to those skilled in the art, and may be made without departing from the spirit or scope of the invention.

What is claimed:

1. A system that joins foam panels comprised of:
a first panel, said first panel having a first upper surface, a first lower surface and a first beveled edge that connects the first upper surface to the first lower surface, wherein the first upper surface and first lower surface are both aligned parallel to a common plane, and wherein the first beveled edge is positioned at a first angle that is other than 90° with respect to the common plane;
a second panel, said second panel having a second upper surface, a second lower surface and a second beveled edge that connects the second upper surface to the second lower surface, wherein the second upper surface and second lower surface are both aligned parallel to the common plane, and wherein the second beveled edge is positioned at a second angle wherein the first and second angles are supplementary angles; and
an adhesive layer, said adhesive layer being placed between the first and second beveled edges, said first beveled edge and the second beveled edge being overlapped at a joinder position;
wherein the first upper surface of the first panel and the second upper surface of the second side panel meet at the joinder position to form an essentially flat surface; and
wherein the first lower surface of the first panel and the second lower surface of the second side panel meet at the joinder position to form an essentially flat surface.

2. The system of claim 1, wherein the first beveled edge is positioned at a first angle that is less than 90°.

3. The method of claim 1, wherein the first beveled edge is positioned at a first angle that is greater than 90°.

4. A method for forming a seal between panels of foam material comprising:
aligning an edge of a first panel to an edge of a second panel, said first panel having a first upper surface, a first lower surface and a first beveled edge that connects the first upper surface to the first lower surface, wherein the first upper surface and first lower surface are both aligned parallel to a common plane,
said second panel having a second upper surface, a second lower surface and a second beveled edge that connects the second upper surface to the second lower surface, wherein the second upper surface and second lower surface are both aligned parallel to the common plane;
securing the lower surface of the first and second panel;
cutting an edge of the first panel at a first angle that is other than 90° with respect to the common plane, to form a first beveled edge;
cutting an edge of the second panel at an second angle to form a second beveled edge, wherein the first and second angles are supplementary angles;
applying adhesive to at least one of the first beveled edge and the second beveled edge;
aligning the first and second beveled edges; and
joining the first and second beveled edges to form the seam;
wherein the first and second beveled edges being overlapped at a joinder position; the first upper surface of the first panel and the second upper surface of the second side panel meet at the joinder position to form an essentially flat surface; and the first lower surface of the first panel and the second lower surface of the second side panel meet at the joinder position to form an essentially flat surface.

5. The method of claim 4, wherein the first angle is less than 90° with respect to the common plane.

6. The method of claim 4, wherein the first angel is greater than 90° with respect to a common plane.
